(19) United States
(12) Patent Application Publication
(10) Pub. No.: US 2022/0144042 A1
(43) Pub. Date: May 12, 2022

(54) THERMAL MANAGEMENT SYSTEM

(71) Applicant: ISUZU MOTORS LIMITED, Shinagawa-ku, Tokyo (JP)

(72) Inventor: Mitsuo KONNO, Fujisawa-shi, Kanagawa (JP)

(21) Appl. No.: 17/436,565

(22) PCT Filed: Mar. 3, 2020
(86) PCT No.: PCT/JP2020/008800

§ 371 Date: Sep. 3, 2021

(30) Foreign Application Priority Data
Mar. 4, 2019 (JP) 2019-038451

(51) Int. Cl. B60H 1/08; B60H 1/00

(52) U.S. Cl. CPC B60H 1/08; B60H 1/00885

(57) ABSTRACT

A thermal management system includes a first flow path through which cooling water is circulatable, a radiator provided in the first flow path to cool the cooling water, a second flow path which branches from a first branch portion of the first flow path and joins a first junction portion of the first flow path and allows the cooling water which passes through the radiator to flow through the first branch portion, a heater provided in the second flow path to heat the cooling water, a heater core provided on a downstream side of the heater in the second flow path and warming air with the cooling water heated by the heater, a third flow path which branches from a second branch portion on a downstream side of the heater core in the second flow path and joins a second junction portion on an upstream side of the heater core in the second flow path, and a switching unit provided in the second branch portion and switching a flow direction of the cooling water which passes through the heater core to at least one of the first junction portion and the second junction portion.

### TECHNICAL FIELD

The present disclosure relates to a thermal management system used in a vehicle.

### BACKGROUND ART

A vehicle includes a cooling system which cools a heat source with cooling water which passes through a radiator and an air-conditioning system which heats air inside the vehicle by guiding the cooling water to a heater core. The air-conditioning system is provided with a heating unit which heats the cooling water and the cooling water which passes through the heating unit flows to the heater core (for example, see Patent Literature 1).

### CITATION LIST

### Patent Literature

Patent Literature 1: JP-A-2007-223418

### SUMMARY OF INVENTION

### Technical Problem

In a recent year, cooling water which passes through a radiator of a cooling system returns to (that is, circulates) the radiator after passing through a heater core of an air-conditioning system. In this case, the cooling water heated in a heating unit is cooled by the radiator. Therefore, even when the cooling water passes through the heater core again after that, air cannot be sufficiently warmed.

Therefore, the present disclosure is made in view of these points and an object of the present disclosure is to effectively warm air with a simple configuration in a system in which flow paths of a cooling system and an air-conditioning system are connected.

### Solution to Problem

One illustrative aspect of the present disclosure provides a thermal management system comprising: a first flow path through which cooling water is circulatable; a radiator provided in the first flow path and configured to cool the cooling water; a second flow path which branches from a first branch portion of the first flow path and joins a first junction portion of the first flow path, the second flow path allowing the cooling water which passes through the radiator to flow through the first branch portion; a heating unit provided in the second flow path and configured to heat the cooling water; a heater core provided on a downstream side of the heating unit in the second flow path and configured to warm air with the cooling water heated by the heating unit; a third flow path which branches from a second branch portion on a downstream side of the heater core in the second flow path and joins a second junction portion on an upstream side of the heater core in the second flow path; and a switching unit provided in the second branch portion and configured to switch a flow direction of the cooling water which passes through the heater core to at least one of the first junction portion and the second junction portion.

The switching unit may switch between: a first switching state in which the flow direction is set to the first junction portion; a second switching state in which the flow direction is set to the first junction portion and the second junction portion; and a third switching state in which the flow direction is set to the second junction portion.

The thermal management system may further include: a temperature detection unit provided between the heating unit and the heater core in the second flow path and configured to detect a temperature of the cooling water; and a control unit configured to control a switching operation of the switching unit based on the temperature detected by the temperature detection unit.

The thermal management system may further comprise a check valve provided between the first branch portion and the second junction portion in the second flow path and configured to restrict the flow of the cooling water from the second junction portion toward the first branch portion.

The third flow path may join the second junction portion on an upstream side of the heating unit in the second flow path.

### Advantageous Effects of Invention

According to the present disclosure, in a system in which the flow paths of the cooling system and the air conditioning system are connected, it is possible to effectively heat the air with a simple configuration.

### BRIEF DESCRIPTION OF DRAWINGS

FIG. 1 is a schematic diagram for illustrating an example of a configuration of a thermal management system 1 according to one embodiment of the present disclosure.

FIG. 2 is a schematic diagram for illustrating the flow of cooling water when a switching unit 40 is in a first switching state.

FIG. 3 is a schematic diagram for illustrating the flow of the cooling water when the switching unit 40 is in a second switching state.

FIG. 4 is a schematic diagram for illustrating the flow of the cooling water when the switching unit 40 is in the third switching state.

### DESCRIPTION OF EMBODIMENT

<Configuration of Thermal Management System>

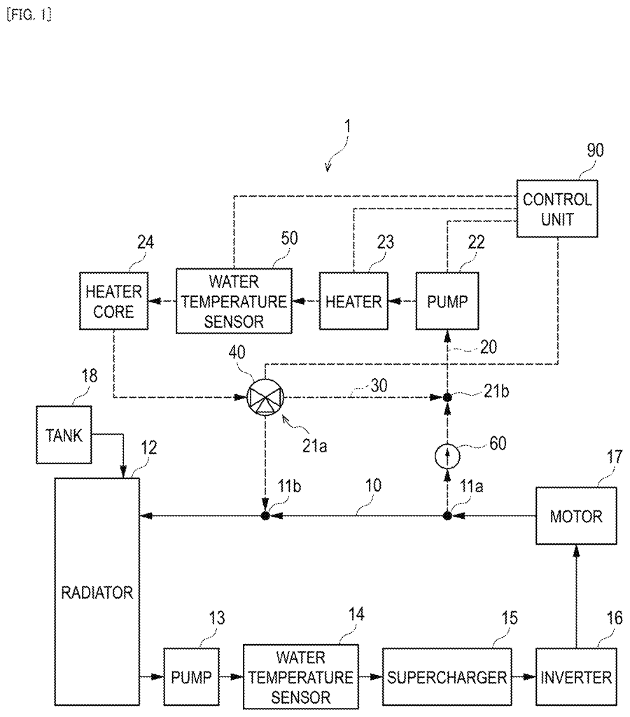

A configuration of a thermal management system 1 according to one embodiment of the present disclosure will be described with reference to FIGS. 1 to 4.

FIG. 1 is a schematic diagram for illustrating an example of the configuration of the thermal management system 1 according to the embodiment. In FIG. 1, for convenience of explanation, a first flow path 10 is shown by a solid line, a second flow path 20 is shown by a broken line, and a third flow path 30 is shown by a dashed-dotted line.

The thermal management system 1 is mounted on a vehicle (for example, a truck), cools a heat source with cooling water, and heats air inside the vehicle with heat of the cooling water. As illustrated in FIG. 1, the thermal management system 1 includes the first flow path 10, the second flow path 20, the third flow path 30, a switching unit 40, a water temperature sensor 50, a check valve 60, and a control unit 90.

The first flow path 10 is a circulation flow path through which cooling water can be circulated. When the cooling water circulates in the first flow path 10, the heat source provided in the first flow path 10 is cooled by the cooling water. That is, the first flow path 10 forms a vehicle cooling system. As illustrated in FIG. 1, a radiator 12, a pump 13, a water temperature sensor 14, a supercharger 15, an inverter 16, and a motor 17 are provided on a path of the first flow path 10.

The radiator 12 cools the cooling water flowing through the first flow path 10. The radiator 12 is, for example, a heat exchanger provided at a front portion of the vehicle and cools the cooling water by exchanging heat between the cooling water flowing through the first flow path 10 and traveling wind.

The pump 13 sucks in and sends out the cooling water so that the cooling water circulates in the first flow path 10. The pump 13 is provided on a downstream side of the radiator 12 in the first flow path 10. The pump 13 operates in response to a command from the control unit 90.

The water temperature sensor 14 detects a temperature of the cooling water flowing through the first flow path 10. The water temperature sensor 14 is provided here on the downstream side of the pump 13. The water temperature sensor 14 outputs a detection result to the control unit 90.

The supercharger 15, the inverter 16, and the motor 17 are heat sources provided on the downstream side of the water temperature sensor 14 in the first flow path 10 and are cooled by the cooling water flowing through the first flow path 10. The heat source is not limited to the above and the heat source may include an engine, for example.

As illustrated in FIG. 1, the second flow path 20 is a flow path which branches from a first branch portion 11a of the first flow path 10 and joins a first junction portion 11b of the first flow path 10. The cooling water that passes through the radiator 12 can flow into the second flow path 20 through the first branch portion 11a. The cooling water flowing through the second flow path 20 flows toward the radiator 12 through the first junction portion 11b. As the cooling water flows through the second flow path 20, heat of the cooling water warms air in a passenger compartment of the vehicle. That is, the second flow path 20 forms an air-conditioning system of the vehicle. As illustrated in FIG. 1, a pump 22, a heater 23, and a heater core 24 are provided on a path of the second flow path 20.

The pump 22 sucks in and sends out the cooling water so that the cooling water circulates in the second flow path 20. The pump 22 operates in response to a command from the control unit 90. For example, the pump 22 starts operating when the heating in the passenger compartment is turned on.

The heater 23 is a heating unit which heats the cooling water flowing through the second flow path 20. The heater 23 is provided on the downstream side of the pump 22 in the second flow path 20. The heater 23 operates in response to a command from the control unit 90. For example, when the heating is turned on, the heater 23 operates in conjunction with the pump 22.

The heater core 24 is a heat exchanger which exchanges heat between the cooling water flowing through the second flow path 20 and the air in the passenger compartment and heats the air with the heat of the cooling water. The heater core 24 is provided on the downstream side of the heater 23 in the second flow path 20. The heater core 24 here heats the air with the cooling water heated by the heater 23. Since the cooling water is heated by the heater 23, it becomes easy to raise the temperature of the air in the passenger compartment to a high temperature.

As illustrated in FIG. 1, the third flow path 30 is a connecting flow path which branches from a second branch portion 21a on the downstream side of the heater core 24 in the second flow path 20 and joins a second junction portion 21b on the upstream side of the heater core 24 in the second flow path 20. By providing the third flow path 30, the cooling water which passes through the heater core 24 will flow to the second flow path 20 without passing through the first flow path 10. As a result, the cooling water which passes through the heater core 24 is not cooled by the radiator 12 of the first flow path 10. Therefore, when the cooling water flows through the second flow path 20 again, the temperature of the cooling water rises when passing through the heater 23, so that the temperature rise of the air in the heater core 24 can be promoted.

As illustrated in FIG. 1, the switching unit 40 is provided at the second branch portion 21a of the second flow path 20. The switching unit 40 is a three-way solenoid valve in this example and switches the flow of the cooling water by turning the port on and off. The switching unit 40 switches a flow direction of the cooling water which passes through the heater core 24 to at least one of the first junction portion 11b and the second junction portion 21b. In the embodiment, the switching unit 40 switches between three switching states (e.g., first switching state, second switching state, and third switching state).

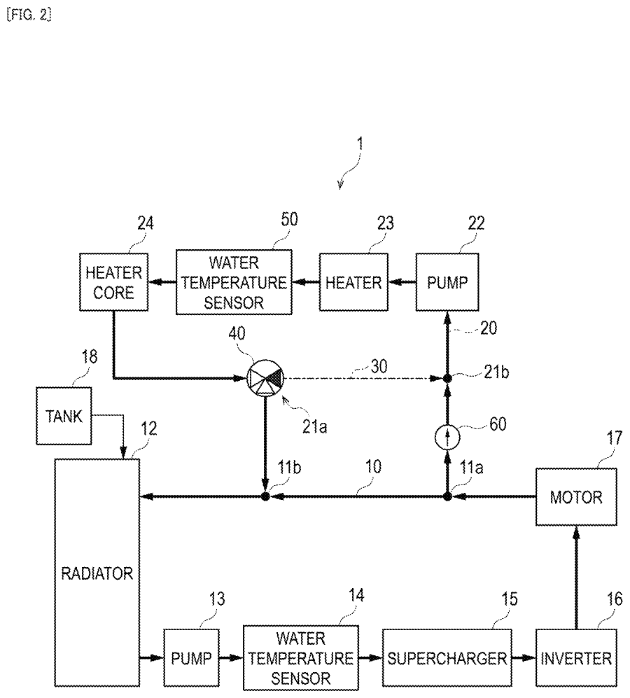

Hereinafter, the flow of the cooling water in the three switching states of the switching unit 40 will be described with reference to FIGS. 2 to 4.

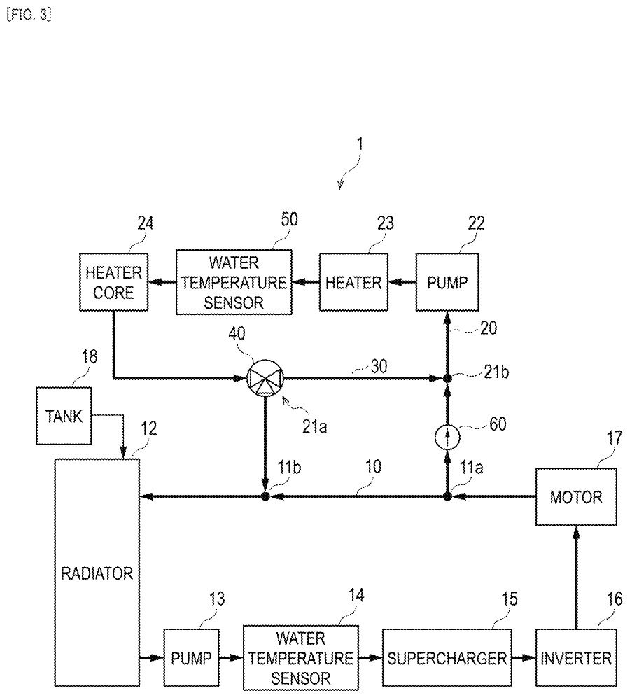

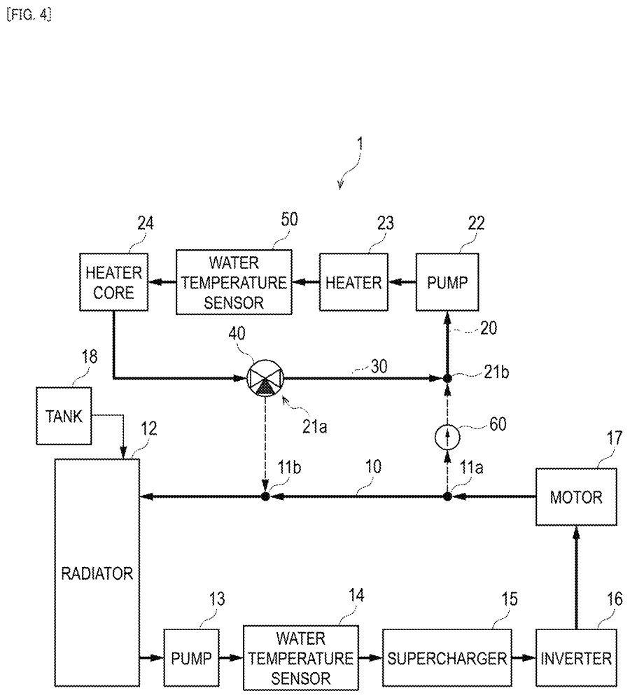

FIG. 2 is a schematic diagram for illustrating the flow of the cooling water when the switching unit 40 is in the first switching state. FIG. 3 is a schematic diagram for illustrating the flow of the cooling water when the switching unit 40 is in the second switching state. FIG. 4 is a schematic diagram for illustrating the flow of the cooling water when the switching unit 40 is in the third switching state. In FIGS. 2 to 4, the flow of the cooling water is shown by a thick line. Incidentally, in FIGS. 2 to 4, the control unit 90 is omitted for convenience of explanation.

As illustrated in FIG. 2, the first switching state is a state in which the cooling water flows from the second branch portion 21a to the first junction portion 11b. In the first switching state, all of the cooling water passing through the second branch portion 21a flows to the first junction portion 11b and then to the radiator 12. That is, in the first switching state, the cooling water circulates in the first flow path 10 and the second flow path 20. A part of the cooling water passing through the first branch portion 11a in the first flow path 10 flows to the second flow path 20 and the remaining cooling water continues to flow through the first flow path 10.

The second switching state is a state in which the cooling water flows to the first junction portion 11b and the second junction portion 21b, as illustrated in FIG. 3. In the second switching state, a part of the cooling water passing through the second branch portion 21a flows to the first junction portion 11b and then to the radiator 12. The rest of the cooling water passing through the second branch portion 21a flows to the second junction portion 21b and then to the heater 23 and the heater core 24 (that is, the cooling water circulates in the second flow path 20).

As illustrated in FIG. 4, the third switching state is a state in which the cooling water flows to the second junction portion 21b. In the third switching state, all of the cooling water passing through the second branch portion 21a flows to the second junction portion 21b and then flows to the heater 23 and the heater core 24. That is, in the third switching state, the cooling water continues to circulate in the second flow path 20. Therefore, the heat of the cooling water flowing through the second flow path 20 quickly warms the air in the passenger compartment. For example, when a set temperature of heating is high and it is needed to warm the air in the passenger compartment at an early stage, the switching unit 40 switches to the third switching state. On the other hand, when the set temperature of the heating is not high, the switching unit 40 switches to the first switching state or the second switching state. Incidentally, in the third switching state, the amount of cooling water in the second flow path 20 does not decrease, so that it is difficult for the cooling water in the first flow path 10 to flow from the first branch portion 11a to the second flow path 20.

By the way, when the heating of the passenger compartment is in an OFF state, the pump 13 of the first flow path 10 operates, but the pump 22 of the second flow path 20 does not operate. Therefore, while the cooling water is circulated in the first flow path 10 by the pump 13, the flow of the cooling water in the second flow path 20 is hardly generated. That is, the cooling water passing through the first branch portion 11a continues to flow through the first flow path 10 toward the radiator 12.

The water temperature sensor 50 is a temperature detection unit which detects the temperature of the cooling water flowing through the second flow path 20. As illustrated in FIG. 1, the water temperature sensor 50 is provided between the heater 23 and the heater core 24 in the second flow path 20. The water temperature sensor 50 detects the temperature of the cooling water which passes through the heater 23.

As illustrated in FIG. 1, the check valve 60 is provided between the first branch portion 11a and the second junction portion 21b in the second flow path 20. The check valve 60 is a valve for regulating a direction of the cooling water flowing through the second flow path 20. Specifically, the check valve 60 regulates the cooling water from flowing (back-flowing) from the second junction portion 21b toward the first branch portion 11a. As a result, the cooling water properly circulates in the second flow path 20 through the third flow path 30.

The control unit 90 is an electronic control unit (ECU) including a microcomputer having, for example, a Central Processing Unit (CPU), a Read Only Memory (ROM), a Random Access Memory (RAM), and the like. The control unit 90 controls the entire operation of the thermal management system 1. For example, when a driver turns on the heating, the control unit 90 operates the pump 22 and the heater 23 and heats the air in the passenger compartment by the heat of the cooling water in the heater core 24.

Further, the control unit 90 controls a switching operation of the switching unit 40 based on the temperature of the cooling water detected by the water temperature sensor 50. That is, the control unit 90 switches the state of the switching unit 40 between the first switching state (FIG. 2), the second switching state (FIG. 3), and the third switching state (FIG. 4), according to the temperature of the cooling water. For example, the control unit 90 controls the switching operation of the switching unit 40 according to a relationship between two threshold values (a first threshold value indicating a predetermined temperature and a second threshold value having a temperature higher than the first threshold value) of the cooling water temperature. Specifically, the control unit 90 sets the state of the switching unit 40 to the first switching state when the temperature of the cooling water is higher than the second threshold value, sets the state of the switching unit 40 to the second switching state when the temperature of the cooling water is between the first threshold value and the second threshold value, and sets the state of the switching unit 40 to the third switching state when the temperature of the cooling water is lower than the first threshold value. Therefore, when the temperature of the cooling water is low, the cooling water continues to circulate in the second flow path 20 by setting the state to the third switching state, so that the cooling water is heated by the heater 23 and the temperature tends to rise early.

Incidentally, in the above description, the switching unit 40 is a solenoid valve which switches the flow of the cooling water by turning the port on and off. However, the switching unit 40 is not limited thereto. For example, the switching unit 40 may be a valve for adjusting an opening degree.

<Effect in Embodiment>

The thermal management system 1 of the embodiment described above includes the first flow path 10 including the radiator 12, the second flow path 20 which connects between the first branch portion 11a and the first junction portion 11b of the first flow path 10 and includes the heater core 24, and the third flow path 30 which connects the second branch portion 21a and the second junction portion 21b of the second flow path 20. In addition, the thermal management system 1 includes the switching unit 40 which is provided in the second branch portion 21a and switches the flow direction of the cooling water which passes through the heater core 24 to at least one of the first junction portion 11b and the second junction portion 21b.

The switching unit 40 switches the flow direction of the cooling water according to the degree of heating the air with the heat of the cooling water in the heater core 24, for example. Specifically, when it is needed to warm the air quickly, the cooling water continues to circulate in the second flow path 20 (cooling water does not flow to the radiator 12) by setting the state of the switching unit 40 to the third switching state illustrated in FIG. 4. As a result, the air in the passenger compartment can be warmed at an early stage by the heat of the cooling water.

Although the invention is described above using the embodiment, the technical scope of the invention is not limited to the scope described in the embodiment and various modifications and changes can be made within the scope of the gist thereof. For example, all or a part of the device can be functionally or physically distributed and integrated in any unit. Also, new embodiments resulting from any combination of a plurality of embodiments are also included in the embodiment of the invention. An effect of the new embodiment produced by the combination has the effect of the original embodiment.

This application is based on a Japanese patent application filed on Mar. 4, 2019 (Japanese Patent Application No. 2019-38451), the contents of which are incorporated herein by reference.

### INDUSTRIAL APPLICABILITY

The invention has the effect of being able to effectively heat air with a simple configuration in a system in which flow paths of a cooling system and an air-conditioning system are connected and is useful for a thermal management system or the like.

### REFERENCE SIGNS LIST

1: thermal management system
10: first flow path
11a: first branch portion
11b: first junction portion
12: radiator
20: second flow path
21a: second branch portion
21b: second junction portion
23: heater
24: heater core
30: third flow path
40: switching unit
50: water temperature sensor
60: check valve
90: control unit

1. A thermal management system comprising:
a first flow path through which cooling water is circulatable;
a radiator provided in the first flow path and configured to cool the cooling water;
a second flow path which branches from a first branch portion of the first flow path and joins a first junction portion of the first flow path, the second flow path allowing the cooling water which passes through the radiator to flow through the first branch portion;
a heating unit provided in the second flow path and configured to heat the cooling water;
a heater core provided on a downstream side of the heating unit in the second flow path and configured to warm air with the cooling water heated by the heating unit;
a third flow path which branches from a second branch portion on a downstream side of the heater core in the second flow path and joins a second junction portion on an upstream side of the heater core in the second flow path; and
a switching unit provided in the second branch portion and configured to switch a flow direction of the cooling water which passes through the heater core to at least one of the first junction portion and the second junction portion.

2. The thermal management system according to claim 1, wherein the switching unit switches between:
a first switching state in which the flow direction is set to the first junction portion;
a second switching state in which the flow direction is set to the first junction portion and the second junction portion; and
a third switching state in which the flow direction is set to the second junction portion.

3. The thermal management system according to claim 1, further comprising:
a temperature detection unit provided between the heating unit and the heater core in the second flow path and configured to detect a temperature of the cooling water; and
a control unit configured to control a switching operation of the switching unit based on the temperature detected by the temperature detection unit.

4. The thermal management system according to claim 1, further comprising:
a check valve provided between the first branch portion and the second junction portion in the second flow path and configured to restrict the flow of the cooling water from the second junction portion toward the first branch portion.

5. The thermal management system according to claim 1, wherein the third flow path joins the second junction portion on an upstream side of the heating unit in the second flow path.
